(19) United States
(12) Patent Application Publication
(10) Pub. No.: US 2025/0193961 A1
(43) Pub. Date: Jun. 12, 2025

(54) TECHNIQUES FOR AMBIENT BACKSCATTERING CONFIGURATION

(71) Applicant: Lenovo (Singapore) Pte. Ltd., Singapore (SG)

(72) Inventors: Ali Ramadan Ali, Kraiburg am Inn (DE); Karthikeyan Ganesan, Nauheim (DE); Ravi Kuchibhotla, Chicago, IL (US)

(21) Appl. No.: 19/054,493

(22) Filed: Feb. 14, 2025

Related U.S. Application Data
(60) Provisional application No. 63/554,570, filed on Feb. 16, 2024.

(51) Int. Cl. H04W 76/25; H04L 1/00; H04W 4/80

(52) U.S. Cl. CPC H04W 76/25; H04W 4/80; H04L 1/0003; H04L 1/0009

(57) ABSTRACT

Various aspects of the present disclosure relate to techniques for preventing bidding down attacks. A base station (BS) is configured to determine a configuration for adapting a backscattering link between the BS and a device configured for ambient backscattering, transmit the configuration to the device configured for ambient backscattering, and receive an indication that the configuration is applied, the indication received in a backscattered signal from the device configured for ambient backscattering.

### TECHNICAL FIELD

The present disclosure relates to wireless communications, and more specifically to techniques for ambient backscattering configuration.

### BACKGROUND

A wireless communications system may include one or multiple network communication devices, such as base stations (BSs), which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A BS for wireless communication is described. The BS may be configured to, capable of, or operable to determine a configuration for adapting a backscattering link between a BS and a device configured for ambient backscattering, transmit the configuration to the device configured for ambient backscattering, and receive an indication that the configuration is applied, the indication received in a backscattered signal from the device configured for ambient backscattering.

A processor for wireless communication is described. The processor may be configured to, capable of, or operable to determine a configuration for adapting a backscattering link between a BS and a device configured for ambient backscattering, transmit the configuration to the device configured for ambient backscattering, and receive an indication that the configuration is applied, the indication received in a backscattered signal from the device configured for ambient backscattering.

A method for wireless communication is described. The method may be configured to, capable of, or operable to determine a configuration for adapting a backscattering link between a BS and a device configured for ambient backscattering, transmit the configuration to the device configured for ambient backscattering, and receive an indication that the configuration is applied, the indication received in a backscattered signal from the device configured for ambient backscattering.

A device for wireless communication is described. The device may be configured to, capable of, or operable to receive a configuration for adapting a backscattering link between a device and a BS, the device configured for ambient backscattering, apply the configuration for adapting the backscattering link, and transmit an indication to the BS that the configuration is applied, the indication transmitted in a backscattered signal.

A processor for wireless communication is described. The processor may be configured to, capable of, or operable to receive a configuration for adapting a backscattering link between a device and a BS, the device configured for ambient backscattering, apply the configuration for adapting the backscattering link, and transmit an indication to the BS that the configuration is applied, the indication transmitted in a backscattered signal.

A method for wireless communication is described. The method may be configured to, capable of, or operable to receive a configuration for adapting a backscattering link between a device and a BS, the device configured for ambient backscattering, apply the configuration for adapting the backscattering link, and transmit an indication to the BS that the configuration is applied, the indication transmitted in a backscattered signal.

A network equipment (NE) for wireless communication is described. The NE may be configured to, capable of, or operable to receive a configuration for adapting a backscattering link between a BS and a device configured for ambient backscattering, determine control information based on the configuration for adapting the backscattering link, and transmit the control information to the device configured for ambient backscattering within or prior to a carrier wave transmission.

A processor for wireless communication is described. The processor may be configured to, capable of, or operable to receive a configuration for adapting a backscattering link between a BS and a device configured for ambient backscattering, determine control information based on the configuration for adapting the backscattering link, and transmit the control information to the device configured for ambient backscattering within or prior to a carrier wave transmission.

A method for wireless communication is described. The method may be configured to, capable of, or operable to receive a configuration for adapting a backscattering link between a BS and a device configured for ambient backscattering, determine control information based on the configuration for adapting the backscattering link, and transmit the control information to the device configured for ambient backscattering within or prior to a carrier wave transmission.

### BRIEF DESCRIPTION OF THE DRAWINGS

FIG. 1 illustrates an example of a wireless communications system in accordance with aspects of the present disclosure.

FIG. 2 illustrates an example of pulse interval encoding (PIE) with different OFF/ON durations for backscattering, in accordance with aspects of the present disclosure.

FIG. 3 illustrates an example of control information sent by the emitter or an intermediate node to an ambient Internet of Things (AIoT) device, in accordance with aspects of the present disclosure.

FIG. 4 illustrates an example of sending an indication of the autonomously selected modulation/coding scheme piggybacked within backscattered data information, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by an NE in accordance with aspects of the present disclosure.

FIG. 9 illustrates a flowchart of a method performed by a device in accordance with aspects of the present disclosure.

FIG. 10 illustrates a flowchart of a method performed by an NE in accordance with aspects of the present disclosure.

### DETAILED DESCRIPTION

Some wireless communication systems may deploy IoT devices. As used herein, an IoT device may refer to a device that may be equipped with one or more sensors, actuators, gadgets, appliances, or machines. The IoT device may be programmed for specific applications and may transmit data over the Internet or other networks. In some cases, the IoT device is powered by batteries that have high maintenance costs. Some other wireless communication systems may deploy AIoT devices that consume less power. As used herein, an AIoT device may refer to an IoT device that is capable of harvesting energy from the environment and may be equipped with an energy storage component (e.g., batteries, capacitors, and the like).

Some AIoT devices may be equipped with an energy storage component, but may not be configured with independent signal generation capability (e.g., backscattering transmission). In these cases, the AIoT devices may support the use of stored energy to amplify reflected signals. Other AIoT devices may be equipped with an energy storage component, as well as support independent signal generation (e.g., via an active RF component).

In a wireless communication system, AIoT devices may be part of different topologies and deployment scenarios. For instance, a topology may include a BS that functions, operates, or is otherwise configured as a reader and as a source of a carrier wave. Another topology may include a BS that functions, operates, or is otherwise configured as a reader, but another device may be used as a source of the carrier wave. Yet another topology may include a BS that functions, operates, or is otherwise configured as a controller and another intermediate node that is used as a reader and as a source of a carrier wave.

In some cases, decoding a backscattered signal at a BS depends on various factors, such as a distance between the BS and an AIoT device, transmit power and distance between an emitter or an intermediate node and the AIoT device, a channel for both links, one or more hardware characteristics of the AIoT device including different types of losses within the circuitry of the AIoT device, as well as other factors such as modulation and coding schemes for modulating and encoding the backscattered signal, or a combination thereof. For mobile AIoT devices, the quality of a backscattering signal varies according to the distance, channel conditions, blockages, or a combination thereof. Therefore, fixed modulation and coding schemes for backscattering may lead to variation of the quality of the decoded information.

Various aspects of the present disclosure relate to configuring an AIoT device and/or an external emitter or an intermediate node to adapt a backscattering communication link. In one embodiment, adapting the backscattering communication link may refer to configuring the modulation and/or coding scheme of the backscattering link, e.g., to conform to quality of service (QOS) requirements in terms of reliability, latency, throughput, or the like. Based on the backscattered signal quality, a BS may send information to an AIoT device to change the current backscattering parameters to meet the QoS of the corresponding application. Aspects of the present disclosure are described in the context of a wireless communications system.

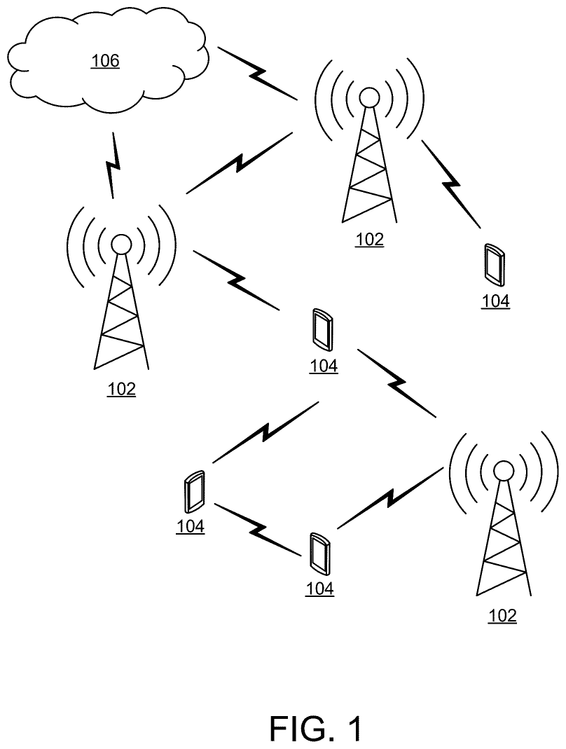

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmit-receive points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., u=0) may be associated with a first subcarrier spacing (e.g., 15 kHz) and a normal cyclic prefix. In some implementations, the first numerology (e.g., u=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., u=2) may be associated with a third subcarrier spacing (e.g., 60 kHz) and a normal cyclic prefix or an extended cyclic prefix. A fourth numerology (e.g., u=3) may be associated with a fourth subcarrier spacing (e.g., 120 kHz) and a normal cyclic prefix. A fifth numerology (e.g., u=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., u=0, u=1, u=2, u=3, u=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., u=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., u=0), which includes 15 kHz subcarrier spacing; a second numerology (e.g., u=1), which includes 30 kHz subcarrier spacing; and a third numerology (e.g., u=2), which includes 60 kHz subcarrier spacing. FR2 may be associated with one or multiple numerologies (e.g., at least 2 numerologies). For example, FR2 may be associated with a third numerology (e.g., u=2), which includes 60 kHz subcarrier spacing; and a fourth numerology (e.g., u=3), which includes 120 kHz subcarrier spacing.

As background, in recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Most of the existing wireless communication devices are powered by batteries that need to be replaced or recharged manually. The automation and digitalization of various industries open numbers of new markets requiring new IoT technologies of supporting battery-less devices with no energy storage capability or devices with energy storage that do not need to be replaced or recharged manually. The form factor of such devices must be reasonably small to convey the validity of target use cases.

AIoT devices are being studied to capture use cases, traffic scenarios, device constraints of AIoT and identify new potential service requirements as well as new key performance indicators (KPIs). AIoT devices that are being studied include either battery-less devices or devices with limited energy storage capability (i.e., using a capacitor) and the energy is provided through the harvesting of radio waves, light, motion, heat, or any other power source that could be seen suitable.

Considering the limited size and complexity required by practical applications for battery-less devices with no energy storage capability or devices with limited energy storage that do not need to be replaced or recharged manually, the output power of an energy harvester is typically from 1 μ W to a few hundreds of μW. Existing cellular devices may not work well with energy harvesting due to their peak power consumption of higher than 10 mW.

An example type of application in TR 22.840 (incorporated herein by reference) is asset identification, which presently has to resort mainly to barcode and radio frequency identification (RFID) in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale networks with seamless coverage for RFID.

Since existing technologies cannot meet all the requirements of target use cases, a new IoT technology is recommended to open new markets within 3GPP systems, whose number of connections and/or device density can be orders of magnitude higher than existing 3GPP IoT technologies. The new IoT technology shall provide complexity and power consumption orders of magnitude lower than the existing 3GPP LPWA technologies (e.g. NB-IoT and eMTC) and shall address use cases and scenarios that cannot otherwise be fulfilled based on existing 3GPP LPWA IoT technologies.

In this disclosure, solutions are proposed for different configurations for adapting the backscattering link between an AIoT device and a BS. Depending on the required QoS for the application, the BS adapts the required backscattering link quality in terms of reliability, latency, or throughput. This may require adapting the parameters used by the AIoT device for modulating and encoding the information. Based on predefined criteria of received backscattered signal quality, the BS sends information to change the current backscattering parameters to meet the QoS of the corresponding application. It is noted that although the described embodiments below are for passive AIoT devices, the embodiments are equally applicable to active AIoT devices.

In a first embodiment, a BS sends a configuration to an AIoT device to adapt the communication link for backscattering. The configuration for link adaptation may include adapting the modulation scheme, coding scheme, modulation factor, or a combination thereof, for the backscattered signal. The performance of decoding the backscattered signal at the BS depends on various factors such as the distance between the BS and the AIoT device, transmit power and distance between the emitter and the AIoT device, the channel for both links, the AIoT hardware characteristics including different types of losses in the device circuit as well as other factors such as the modulation and coding schemes used for modulating and encoding the backscattered signal.

In one embodiment, based on predefined QoS requirements of the backscattered signal, which may vary depending on the application or type of data sent by the AIoT device, the BS may send control information to the AIoT device to change the modulation scheme, coding scheme, pulse period, or combination thereof. For example, if the application requires high throughput of the backscattered information, the BS may indicate to the AIoT device to switch to an encoder that provides higher throughput or increases the code rate of the used encoder.

In another example, for high reliability applications, the BS may configure the AIoT device to reduce the code rate or apply repetition of the backscattered information. On the other hand, adapting pulse duration for ON and OFF states may help in changing the latency of the backscattered information, depending on the application. In one implementation, BS sends information to the AIoT device to change code rate of the used encoder, e.g., adapting the rate of Miller encoder. For example, changing the code rate of a Miller encoder from Miller-4 to Miller-2 may increase the throughput for the backscattered information.

In another implementation, the BS configures the AIoT device to switch between different types of encoders such as Miller, Manchester, FM0, PIE, or the like, e.g., switching from Miller to FMO encoder to increase throughput. In another implementation, the BS may indicate to the AIoT device to apply repetition on the backscattered information to enhance the reliability, e.g., based on a predefined threshold of the received backscattering signal power or the error rate of the previously received backscattered information, the BS may request the AIoT device to perform repetition of the backscattered information.

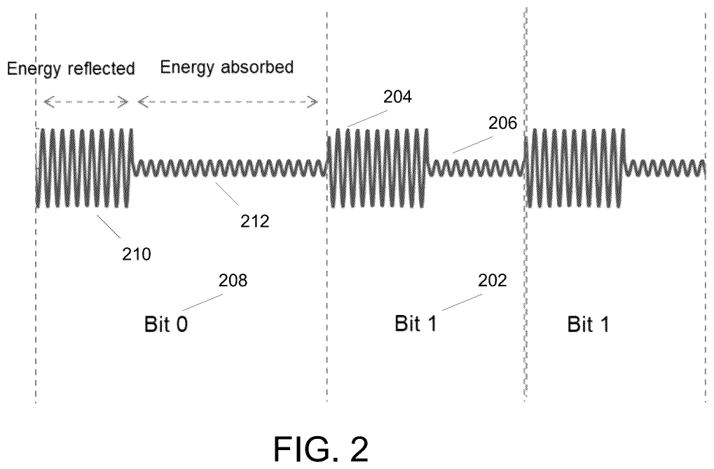

In another implementation, the BS may configure the AIoT device to adapt the pulse length for ON and OFF states. In one example, the BS may configure the AIoT device to double or halve the pulse duration for both ON and OFF states. In another example, the BS may indicate to the AIoT device to use different durations for OFF and ON states. This might be helpful for harvesting as much energy as possible from the carrier wave, e.g., if the OFF duration is larger than the ON duration, the amount of reflected energy is reduced because, during the OFF duration, the matching network works on near full load to absorb most of carrier wave energy. This scheme can be combined with PIE for the backscattering, as shown in FIG. 2.

FIG. 2 illustrates an example of PIE with different OFF/ON durations for backscattering, in accordance with aspects of the present disclosure. In the depicted embodiment, Bit 1s 202 are encoded with a short power up pulse 204 followed by a short power down pulse 206 and Bit 0s 208 are encoded with a short power up pulse 210 followed by a long power down pulse 212.

In one embodiment, to match the required coding, modulation, and pulse duration for backscattering with the carrier wave used for carrying backscattering information, the BS configures the emitter accordingly. The period for transmitting the carrier wave varies depending on the required time for backscattering the modulated and encoded information, which depends on the code rate, pulse duration, number of repetitions, or a combination thereof.

In one embodiment, the BS sends the configuration to the AIoT device within the downlink (DL) signal used to command the AIoT or to write data to AIoT memory. The BS configures the AIoT device with the location of the bit field used to carry the control information for adapting the backscattering link. In one example, this field is located within the header of the DL frame transmitted to the AIoT device. Multiple bits can be used to indicate different coding schemes, different coding rates, different pulse duration ratios between OFF and ON states, and/or a number of the repetitions to be applied on the backscattered information.

In a second embodiment, the BS sends a configuration to an external emitter or an intermediate node to send, within or before the carrier wave, control information to adapt the backscattering link of an AIoT. The BS may send the control information to the AIoT via the external emitter or an intermediate node, e.g., if there are not enough resources in DL to communicate with one or more AIoT devices, the control information can be forwarded by the external emitter or an intermediate node. The configuration for link adaptation may include adapting the modulation scheme, coding scheme, modulation factor, or the like, for the backscattered signal.

In one embodiment, based on predefined QoS requirements of the backscattered signal, which may vary depending on the application or type of data sent by the AIoT device, the emitter or an intermediate node may send control information to the AIoT device to change the modulation scheme, coding scheme, pulse period, or a combination thereof. In one implementation, the emitter or an intermediate node is configured to send information to the AIoT device to change the code rate of the used encoder. The BS configures the emitter or an intermediate node with the corresponding period for transmitting the carrier wave associated with the backscattering required time for different coding, modulation, or repetition schemes.

In another implementation, the emitter or an intermediate node is configured to send, along with the carrier wave, information to the AIoT device to switch between different types of encoders such as Miller, Manchester, FM0, PIE, or the like. In another implementation, the emitter or an intermediate node may be configured to indicate to the AIoT device to apply repetition on the backscattered information to enhance the reliability at the BS. In another implementation, the emitter or an intermediate node may be configured to indicate to the AIoT device to adapt the pulse length for ON and OFF states.

In one embodiment, the BS sends the configuration to the emitter or an intermediate node using, e.g., uplink (UL) downlink control information (DCI) if the emitter or an intermediate node is a UE or using inter-TRP or F1 interface if the emitter or an intermediate node is a TRP. Bit field in the DCI can be used to indicate different modulation/coding schemes for backscattering.

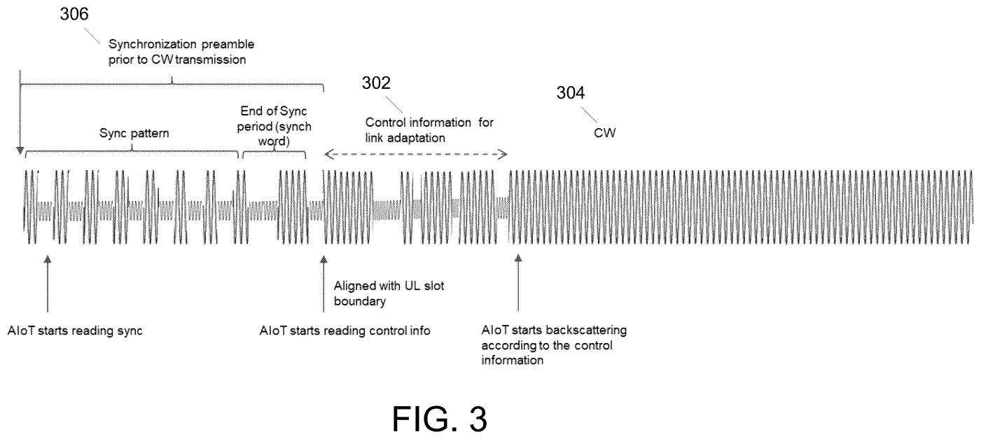

FIG. 3 illustrates an example of control information sent by the emitter or an intermediate node to an AIoT device, in accordance with aspects of the present disclosure. As shown in FIG. 3, the emitter or an intermediate node sends the link adaptation control information 302 prior to a carrier wave 304 used for backscattering. In one example, if the AIoT device has synchronization with the BS, the AIoT switches its reception to read the link adaptation control information 302 from the carrier wave 304 transmitted in specific slots/symbols and accordingly change the modulation coding scheme based on the link adaptation control information 302 and applies the requested scheme on the carrier wave 304 while backscattering. The link adaptation control information 302 can be sent after a synchronization signal 306 sent by the emitter or an intermediate node to correct the synchronization and to align reading the link adaptation control information 302 from the emitter or an intermediate node with the correct symbol/slot boundary.

In a third embodiment, the BS configures the AIoT device to autonomously switch between different modulation and coding schemes. The BS configures the AIoT device with a list of different modulation and coding schemes to switch between and list of code rate and pulse lengths to adapt based on pre-defined criteria. These criteria may include the intensity of the received carrier wave, the level of stored energy at the AIoT device, and/or the capability supported by the AIoT device. The AIoT device autonomously changes the modulation scheme, coding scheme, pulse period, or a combination thereof.

In one implementation, the AIoT device changes the code rate of the used encoder. In another implementation, the AIoT device switches between different types of encoders such as Miller, Manchester, FM0, PIE, or the like, depending on the stored energy, its capability to support one or more of these encoders, or the like. In another implementation, the AIoT device applies repetition on the backscattered information depending on the intensity of the received carrier wave to enhance the reliability at the BS. In another implementation, the AIoT device adapts the pulse length for ON and OFF states, e.g., increasing the OFF state or reducing the ON state to save or harvest more energy from the carrier wave. In one implementation, the AIoT device is configured by the BS to indicate the selected modulation, coding, or repetition scheme.

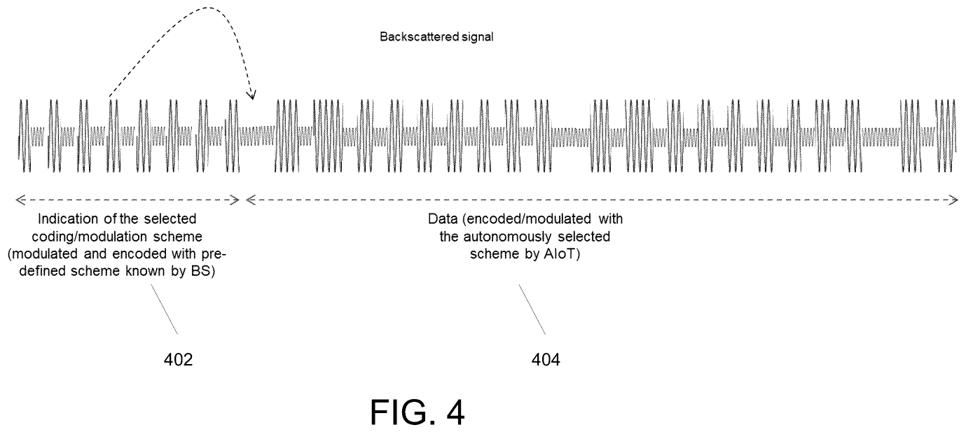

FIG. 4 illustrates an example of sending an indication 402 of the autonomously selected modulation/coding scheme piggybacked within backscattered data information 404, in accordance with aspects of the present disclosure. In one example, the BS configures the AIoT device to send the indication 402 in a predefined bit field piggybacked within the backscattered data information 404 with predefined schemes, i.e., the indication 402 of the modulation and coding scheme that is applied is pre-known to the BS or the scheme is the same scheme used for previous communication with the BS. In another example, the indication 402 can be sent separately in a predefined location to indicate the change to be applied on the next backscattered data information 404.

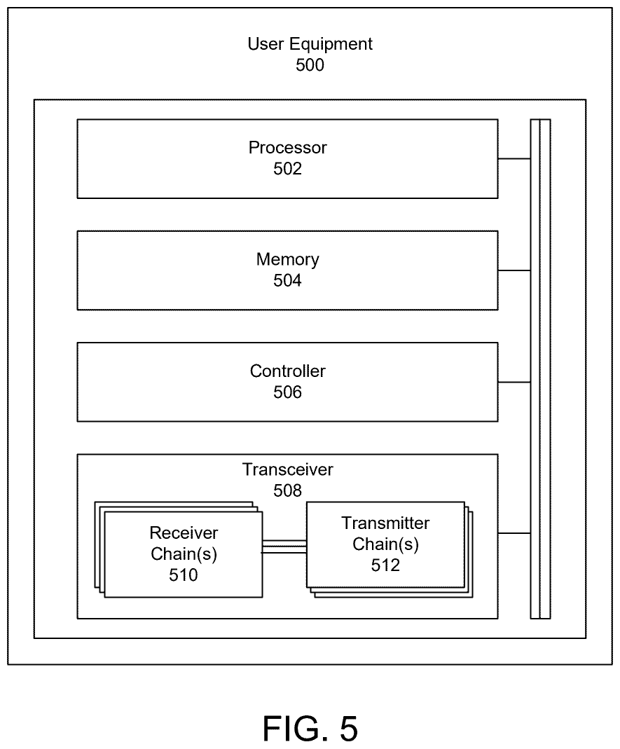

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding and processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

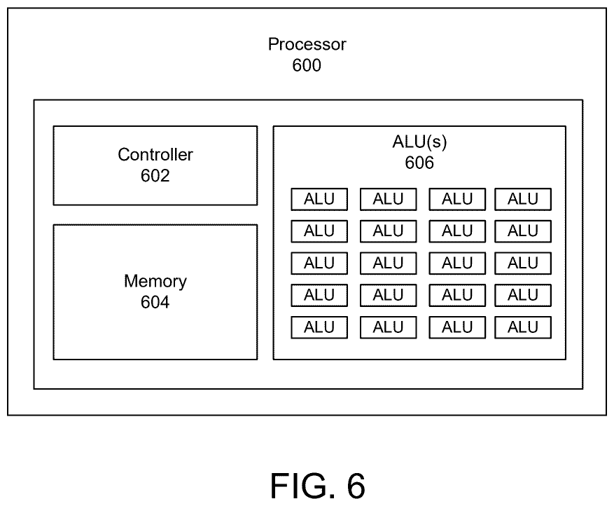

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. In one embodiment, the processor 600 may be configured to or operable to support a means to determine a configuration for adapting a backscattering link between the BS and a device configured for ambient backscattering, transmit the configuration to the device configured for ambient backscattering, and receive an indication that the configuration is applied, the indication received in a backscattered signal from the device configured for ambient backscattering.

In one embodiment, the device configured for ambient backscattering comprises an ambient Internet of Things device. In one embodiment, the processor 600 may be configured to or operable to support a means to transmit the configuration to an external emitter for forwarding to the device configured for ambient backscattering.

In one embodiment, the configuration comprises information for forwarding control information from the external emitter to the device configured for ambient backscattering within or prior to a carrier wave transmission.

In one embodiment, the configuration comprises information for changing at least one of a coding scheme, a modulation scheme, a coding rate, a pulse duration state, or a combination thereof associated with the backscattered signal.

In one embodiment, the configuration comprises information indicating a number of repetitions to be applied for the backscattered signal. In one embodiment, the configuration comprises information for adapting a pulse length for ON and OFF states to the backscattered signal. In one embodiment, the configuration comprises information for adapting pulse interval encoding for the backscattered signal.

In one embodiment, the processor 600 may be configured to or operable to support a means to transmit the configuration to the device configured for ambient backscattering in a downlink signal, wherein control information for adapting the backscattering link is located within a bit field of a header of the downlink signal.

In one embodiment, the configuration comprises information for the device configured for ambient backscattering to autonomously switch between different modulation schemes, coding schemes, or a combination thereof.

In one embodiment, the different modulation schemes, coding schemes, or a combination thereof are determined based on an intensity of a received carrier wave, a level of stored energy, device capabilities, or a combination thereof.

In one embodiment, the processor 600 may be configured to or operable to support a means to receive the indication that the configuration is applied in a predefined bit field within the backscattered signal, the indication comprising an applied modulation scheme, coding scheme, repetition scheme, or a combination thereof.

In one embodiment, the processor 600 may be configured to or operable to support a means to receive a configuration for adapting a backscattering link between the NE and a BS, the NE configured for ambient backscattering, apply the configuration for adapting the backscattering link, and transmit an indication to the BS that the configuration is applied, the indication transmitted in a backscattered signal.

In one embodiment, the NE comprises an ambient Internet of Things device. In one embodiment, the processor 600 may be configured to or operable to support a means to change at least one of a coding scheme, a modulation scheme, a coding rate, a pulse duration state, or a combination thereof associated with the backscattered signal according to the configuration.

In one embodiment, the processor 600 may be configured to or operable to support a means to apply a number of repetitions to the backscattered signal according to the configuration. In one embodiment, the processor 600 may be configured to or operable to support a means to adapt a pulse length for ON and OFF states to the backscattered signal according to the configuration.

In one embodiment, the processor 600 may be configured to or operable to support a means to adapt pulse interval encoding to the backscattered signal according to the configuration. In one embodiment, the processor 600 may be configured to or operable to support a means to receive the configuration from an external emitter within or prior to a carrier wave transmission.

In one embodiment, the processor 600 may be configured to or operable to support a means to switch reception to read control information from the carrier wave transmitted in a specific slot or symbol, change the modulation coding scheme based on the control information, and apply the modulation coding scheme on the carrier wave while backscattering.

In one embodiment, the processor 600 may be configured to or operable to support a means to autonomously switch between different modulation schemes, coding schemes, or a combination thereof. In one embodiment, the different modulation schemes, coding schemes, or a combination thereof are determined based on an intensity of a received carrier wave, a level of stored energy of the NE, capabilities of the NE, or a combination thereof.

In one embodiment, the processor 600 may be configured to or operable to support a means to transmit an indication that the configuration is applied in a predefined bit field within the backscattered signal, the indication comprising an applied modulation scheme, coding scheme, repetition scheme, or a combination thereof.

In one embodiment, the processor 600 may be configured to or operable to support a means to receive a configuration for adapting a backscattering link between a BS and a device configured for ambient backscattering, determine control information based on the configuration for adapting the backscattering link, and transmit the control information to the device configured for ambient backscattering within or prior to a carrier wave transmission.

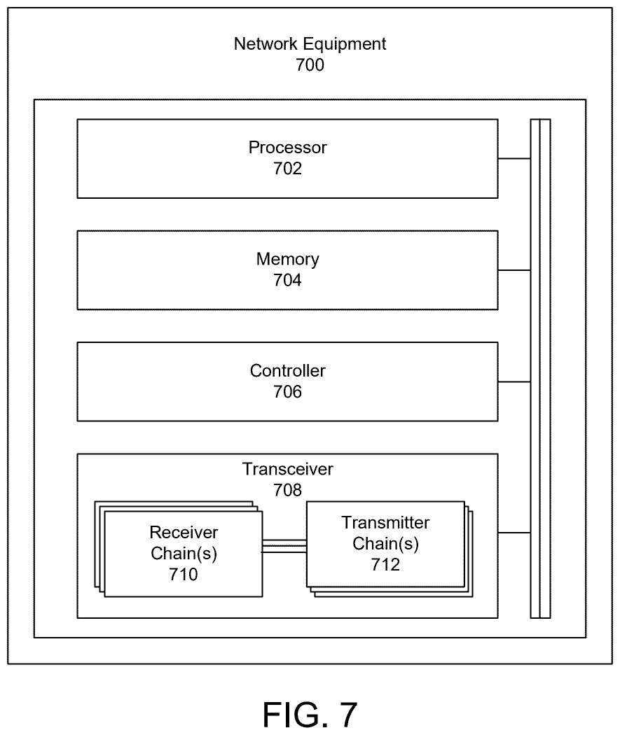

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The NE 700 may be configured to support a means to determine a configuration for adapting a backscattering link between the BS and a device configured for ambient backscattering, transmit the configuration to the device configured for ambient backscattering, and receive an indication that the configuration is applied, the indication received in a backscattered signal from the device configured for ambient backscattering.

In one embodiment, the device configured for ambient backscattering comprises an ambient Internet of Things device. In one embodiment, the NE 700 may be configured to support a means to transmit the configuration to an external emitter for forwarding to the device configured for ambient backscattering.

In one embodiment, the configuration comprises information for forwarding control information from the external emitter to the device configured for ambient backscattering within or prior to a carrier wave transmission.

In one embodiment, the configuration comprises information for changing at least one of a coding scheme, a modulation scheme, a coding rate, a pulse duration state, or a combination thereof associated with the backscattered signal.

In one embodiment, the configuration comprises information indicating a number of repetitions to be applied for the backscattered signal. In one embodiment, the configuration comprises information for adapting a pulse length for ON and OFF states to the backscattered signal. In one embodiment, the configuration comprises information for adapting pulse interval encoding for the backscattered signal.

In one embodiment, the NE 700 may be configured to support a means to transmit the configuration to the device configured for ambient backscattering in a downlink signal, wherein control information for adapting the backscattering link is located within a bit field of a header of the downlink signal.

In one embodiment, the configuration comprises information for the device configured for ambient backscattering to autonomously switch between different modulation schemes, coding schemes, or a combination thereof.

In one embodiment, the different modulation schemes, coding schemes, or a combination thereof are determined based on an intensity of a received carrier wave, a level of stored energy, device capabilities, or a combination thereof.

In one embodiment, the NE 700 may be configured to support a means to receive the indication that the configuration is applied in a predefined bit field within the backscattered signal, the indication comprising an applied modulation scheme, coding scheme, repetition scheme, or a combination thereof.

In one embodiment, the NE 700 may be configured to support a means to receive a configuration for adapting a backscattering link between the NE 70 and a BS, the NE 700 configured for ambient backscattering, apply the configuration for adapting the backscattering link, and transmit an indication to the BS that the configuration is applied, the indication transmitted in a backscattered signal.

In one embodiment, the NE 700 comprises an ambient Internet of Things device. In one embodiment, the NE 700 may be configured to support a means to change at least one of a coding scheme, a modulation scheme, a coding rate, a pulse duration state, or a combination thereof associated with the backscattered signal according to the configuration.

In one embodiment, the NE 700 may be configured to support a means to apply a number of repetitions to the backscattered signal according to the configuration. In one embodiment, the NE 700 may be configured to support a means to adapt a pulse length for ON and OFF states to the backscattered signal according to the configuration.

In one embodiment, the NE 700 may be configured to support a means to adapt pulse interval encoding to the backscattered signal according to the configuration. In one embodiment, the NE 700 may be configured to support a means to receive the configuration from an external emitter within or prior to a carrier wave transmission.

In one embodiment, the NE 700 may be configured to support a means to switch reception to read control information from the carrier wave transmitted in a specific slot or symbol, change the modulation coding scheme based on the control information, and apply the modulation coding scheme on the carrier wave while backscattering.

In one embodiment, the NE 700 may be configured to support a means to autonomously switch between different modulation schemes, coding schemes, or a combination thereof. In one embodiment, the different modulation schemes, coding schemes, or a combination thereof are determined based on an intensity of a received carrier wave, a level of stored energy of the NE 700, capabilities of the NE 700, or a combination thereof.

In one embodiment, the NE 700 may be configured to support a means to transmit an indication that the configuration is applied in a predefined bit field within the backscattered signal, the indication comprising an applied modulation scheme, coding scheme, repetition scheme, or a combination thereof.

In one embodiment, the NE 700 may be configured to support a means to receive a configuration for adapting a backscattering link between a BS and a device configured for ambient backscattering, determine control information based on the configuration for adapting the backscattering link, and transmit the control information to the device configured for ambient backscattering within or prior to a carrier wave transmission.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 causes the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding and processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

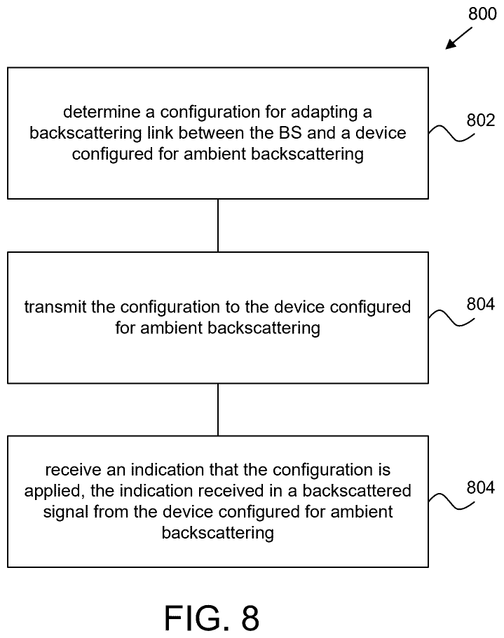

FIG. 8 illustrates a flowchart of a method in accordance with aspects of the present disclosure. The operations of the method may be implemented by a BS or NE as described herein. In some implementations, the BS or NE may execute a set of instructions to control the function elements of the BS or NE to perform the described functions.

At 802, the method may determine a configuration for adapting a backscattering link between the BS and a device configured for ambient backscattering. The operations of 802 may be performed in accordance with examples as described herein. In some implementations, aspects of the operations of 802 may be performed by an NE as described with reference to FIG. 7.

At 804, the method may transmit the configuration to the device configured for ambient backscattering. The operations of 804 may be performed in accordance with examples as described herein. In some implementations, aspects of the operations of 804 may be performed by an NE as described with reference to FIG. 7.

At 806, the method may receive an indication that the configuration is applied, the indication received in a backscattered signal from the device configured for ambient backscattering. The operations of 806 may be performed in accordance with examples as described herein. In some implementations, aspects of the operations of 806 may be performed by an NE as described with reference to FIG. 7.

It should be noted that the method described herein describes a possible implementation, and that the operations and the steps may be rearranged or otherwise modified and that other implementations are possible.

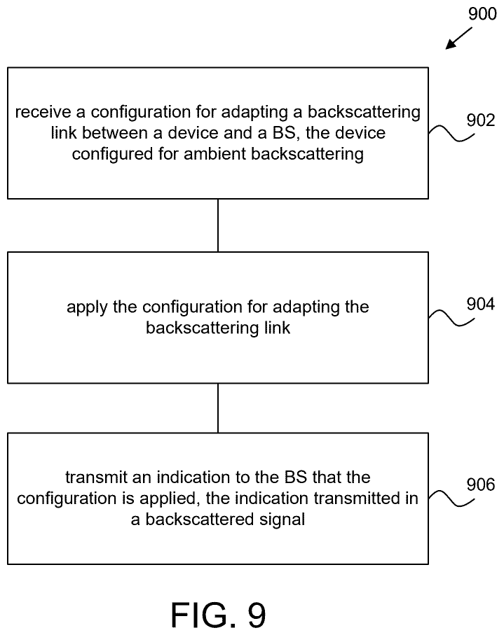

FIG. 9 illustrates a flowchart of a method in accordance with aspects of the present disclosure. The operations of the method may be implemented by a network-connected device, such as an AIoT device as described herein. In some implementations, the device may execute a set of instructions to control the function elements of the device to perform the described functions.

At 902, the method may receive a configuration for adapting a backscattering link between the device and a BS, the device configured for ambient backscattering. The operations of 902 may be performed in accordance with examples as described herein. In some implementations, aspects of the operations of 902 may be performed by a device as described with reference to FIGS. 5 and 7.

At 904, the method may apply the configuration for adapting the backscattering link. The operations of 904 may be performed in accordance with examples as described herein. In some implementations, aspects of the operations of 904 may be performed by a device as described with reference to FIGS. 5 and 7.

At 906, the method may transmit an indication to the BS that the configuration is applied, the indication transmitted in a backscattered signal. The operations of 906 may be performed in accordance with examples as described herein. In some implementations, aspects of the operations of 906 may be performed by a device as described with reference to FIGS. 5 and 7.

It should be noted that the method described herein describes a possible implementation, and that the operations and the steps may be rearranged or otherwise modified and that other implementations are possible.

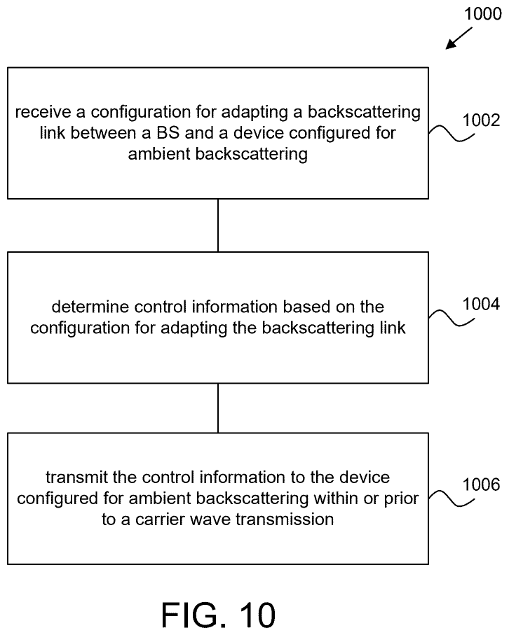

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may receive a configuration for adapting a backscattering link between a BS and a device configured for ambient backscattering. The operations of 1002 may be performed in accordance with examples as described herein. In some implementations, aspects of the operations of 1002 may be performed by an NE as described with reference to FIG. 7.

At 1004, the method may determine control information based on the configuration for adapting the backscattering link. The operations of 1004 may be performed in accordance with examples as described herein. In some implementations, aspects of the operations of 1004 may be performed by an NE as described with reference to FIG. 7.

At 1006, the method may transmit the control information to the device configured for ambient backscattering within or prior to a carrier wave transmission. The operations of 1006 may be performed in accordance with examples as described herein. In some implementations, aspects of the operations of 1006 may be performed by an NE as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station (BS) for wireless communication, comprising:
at least one memory; and
at least one processor coupled with the at least one memory and configured to cause the BS to:
determine a configuration for adapting a backscattering link between the BS and a device configured for ambient backscattering;
transmit the configuration to the device configured for ambient backscattering; and
receive an indication that the configuration is applied, the indication received in a backscattered signal from the device configured for ambient backscattering.

2. The BS of claim 1, wherein the device configured for ambient backscattering comprises an ambient Internet of Things device.

3. The BS of claim 1, wherein the at least one processor is configured to cause the BS to:
transmit the configuration to an external emitter for forwarding to the device configured for ambient backscattering.

4. The BS of claim 3, wherein the configuration comprises information for forwarding control information from the external emitter to the device configured for ambient backscattering within or prior to a carrier wave transmission.

5. The BS of claim 1, wherein the configuration comprises information for changing at least one of a coding scheme, a modulation scheme, a coding rate, a pulse duration state, or a combination thereof associated with the backscattered signal.

6. The BS of claim 1, wherein the configuration comprises information indicating a number of repetitions to be applied for the backscattered signal.

7. The BS of claim 1, wherein the configuration comprises information for adapting a pulse length for ON and OFF states to the backscattered signal.

8. The BS of claim 7, wherein the configuration comprises information for adapting pulse interval encoding for the backscattered signal.

9. The BS of claim 1, wherein the at least one processor is configured to cause the BS to:
transmit the configuration to the device configured for ambient backscattering in a downlink signal, wherein control information for adapting the backscattering link is located within a bit field of a header of the downlink signal.

10. The BS of claim 1, wherein the configuration comprises information for the device configured for ambient backscattering to autonomously switch between different modulation schemes, coding schemes, or a combination thereof.

11. The BS of claim 10, wherein the different modulation schemes, coding schemes, or a combination thereof are determined based on an intensity of a received carrier wave, a level of stored energy, device capabilities, or a combination thereof.

12. The BS of claim 1, wherein the at least one processor is configured to cause the BS to:
receive the indication that the configuration is applied in a predefined bit field within the backscattered signal, the indication comprising an applied modulation scheme, coding scheme, repetition scheme, or a combination thereof.

13. A processor for wireless communication, comprising:
at least one controller coupled with at least one memory and configured to cause the processor to:
determine a configuration for adapting a backscattering link between a base station (BS) and a device configured for ambient backscattering;
transmit the configuration to the device configured for ambient backscattering; and
receive an indication that the configuration is applied, the indication received in a backscattered signal from the device configured for ambient backscattering.

14. A method performed by a base station (BS), the method comprising:
determining a configuration for adapting a backscattering link between the BS and a device configured for ambient backscattering;
transmitting the configuration to the device configured for ambient backscattering; and
receiving an indication that the configuration is applied, the indication received in a backscattered signal from the device configured for ambient backscattering.

15. The method of claim 14, wherein the device configured for ambient backscattering comprises an ambient Internet of Things device.

16. The method of claim 14, further comprising:
transmitting the configuration to an external emitter for forwarding to the device configured for ambient backscattering.

17. A device for wireless communication, comprising:
at least one memory; and
at least one processor coupled with the at least one memory and configured to cause the device to:
receive a configuration for adapting a backscattering link between the device and a base station (BS), the device configured for ambient backscattering;
apply the configuration for adapting the backscattering link; and
transmit an indication to the BS that the configuration is applied, the indication transmitted in a backscattered signal.

18. The device of claim 17, wherein the device comprises an ambient Internet of Things device.

19. The device of claim 17, wherein the at least one processor is configured to cause the device to:
change at least one of a coding scheme, a modulation scheme, a coding rate, a pulse duration state, or a combination thereof associated with the backscattered signal according to the configuration.

20. The device of claim 17, wherein the at least one processor is configured to cause the device to:
apply a number of repetitions to the backscattered signal according to the configuration.
